(19) United States
(12) Patent Application Publication
(10) Pub. No.: US 2007/0229531 A1
(43) Pub. Date: Oct. 4, 2007

(54) Wireless terminal and method for personalizing display colors of menu screen using color information of an image

(75) Inventors: Jung-Hoon Park, Suwon-si (KR); Yun-Je Oh, Yongin-si (KR); Sung-Dae Cho, Yongin-si (KR); Young-Min Jeong, Suwon-si (KR); Jae-Won Moon, Bucheon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/636,831

(22) Filed: Dec. 11, 2006

(30) Foreign Application Priority Data
Mar. 28, 2006 (KR) 2006-27981

(51) Int. Cl. G09G 5/02

(52) U.S. Cl. 345/589

(57) ABSTRACT

A wireless terminal for personalizing display colors of a menu screen using color information of an image, wherein the wireless terminal includes; a memory for storing the image captured by the camera module; an image processing unit for determining colors used to display the menu screen using color information of an image for personalizing the display colors of the menu screen, the image being selected from among images stored in the memory; a display unit for displaying the menu screen with the colors determined by the image processing unit; and a controller for controlling the image processing unit to convert a color model of the selected image to a Hue, Saturation, and Intensity (HSI) color model, extract color values, and map the extracted color values, assign priority to the colors by measuring distribution ratios of the mapped color values, combine the display colors of the menu screen based on the priority of the assigned colors, and finally determine the display colors of the menu screen by analyzing contrast of the combined colors.

### CLAIM OF PRIORITY

This application claims priority under 35 U.S.C. §119 to an application entitled “Wireless Terminal and Method for Personalizing Display Colors of Menu Screen Using Color Information of An Image,” filed in the Korean Intellectual Property Office on Mar. 28, 2006 and assigned Serial No. 2006-27981, the contents of which are incorporated herein by reference.

### BACKGROUND OF THE INVENTION

1. Field of the Invention

The present invention relates generally to a wireless terminal, and in particular, to a wireless terminal and method for personalizing display colors of a menu screen thereof using color information of an image stored in the terminal.

2. Description of the Related Art

Camera-equipped wireless terminals for displaying a moving picture and transmitting and receiving an image have recently become available on the market. In general, a wireless terminal is a device, such as a cellular phone, a Personal Communication Services Phone (PCS), an International Mobile Telecommunication (IMT)-2000 terminal, a Global System for Mobile Communication (GSM) terminal, or a Digital Multimedia Broadcasting (DMB) receiver, for providing a DMB receiving function and a function of making a phone call and exchanging data.

A camera-equipped wireless terminal uses one of a Charge Coupled Device (CCD) or Complementary Metal Oxide Semiconductor (CMOS) as an image pickup element and has an Automatic Gain Control (AGC) function. The AGC function is a function of automatically controlling light intensity so that a luminance mean value of a captured image based on an AGC reference area set in the center portion of the image is within a predetermined range and thus a subject for photographing can be sensed even in a bright or dark environment. More particularly, when an image is captured, a mean value is calculated of luminance values of image signals sensed by sensors in the center portion corresponding to the AGC reference area among sensors of an image pickup element and it is determined whether the calculated luminance mean value is within a pre-set threshold range, the range having an upper and a lower limit value. Light intensity is increased or decreased by an iris adjustment so that the calculated luminance mean value is within the pre-set threshold range. That is, if it is determined that the calculated luminance mean value is greater than the upper limit value of the pre-set threshold range, the light intensity is decreased. And, if it is determined that the luminance mean value is less than the lower limit value of the pre-set threshold range, the light intensity is increased. By repeating the iris adjustment, an optimal image of a subject for photographing can be obtained even in a bright or dark environment.

The wireless terminal includes a color Liquid Crystal Display (LCD) as a display unit for displaying an image and thus can receive and display various kinds of content. In particular, since the color LCD can display a screen composed of a plurality of colors, which a user could not see using a monochrome LCD, the personality of the user can be expressed using the wireless terminal.

Using a wireless terminal comprising the color LCD, a background screen can be downloaded from a service provider or directly edited by the user using the camera-equipped wireless terminal, and thus, various kinds of background screens can be selectively displayed on the color LCD.

A menu screen is comprised of text, a text background, and an overall background. A color change of the menu screen can be achieved by moving to a sub-menu used to change colors of the menu screen and selecting colors desired by the user from among colors pre-set by a manufacturer of the wireless terminal.

FIGS. 1A and 1B are diagrams illustrating a method of changing colors of a menu screen in a conventional wireless terminal. A user of a conventional wireless terminal can change colors of a text background and an overall background by selecting a desired one of 4 pre-set color samples (1)-(4), illustrated in FIG. 1A.

When the user selects a first color sample from the menu illustrated in FIG. 1A, the user is shown that colors of a text background and an overall background of a sub-menu screen for selecting a font, which is illustrated in FIG. 1B, have been changed to colors of the selected first color sample. The user can then select a font and a font color using the sub-menu screen illustrated in FIG. 1B.

However, when colors of the menu screen of the conventional wireless terminal are changed, since the menu bar and menu colors are pre-defined as illustrated in FIGS. 1A and 1B, if a color set desired by the user does not exist, a change to the color set desired by the user is not possible. And, even if a partial color change is allowed, if any color desired by the user does not exist in the menu, a change to colors desired by the user is not possible.

Wireless terminals have a characteristic that allows the personality of users to be expressed therewith as compared to other devices, e.g., a variety of exterior colors, designs, and accessories are provided with which a user personalizes the wireless terminal. However, since their menu screens are pre-formatted, users cannot be satisfied who desire to display color variations of these menu screens.

### SUMMARY OF THE INVENTION

The present invention provides a wireless terminal and method for personalizing display colors of a menu screen of the terminal using color information of user-specified images stored in the terminal, whereby an environment for implementing a specific menu color is provided by setting the display colors of the menu screen using images stored in the wireless terminal, a complicated process of selecting a color is simplified, and a personality of a user is expressed.

According to one aspect of the present invention, there is provided a wireless terminal for personalizing display colors of a menu screen thereof using color information of an image, the wireless terminal comprising: a camera module for capturing the image; a memory for storing the image captured by the camera module as one of a plurality of stored images; an image processing unit for determining colors used to display the menu screen using color information of the image for personalizing the display colors of the menu screen, said image being selected from among said plurality of images stored in the memory; a display unit for displaying the menu screen with the colors determined by the image processing unit using the selected image; and a controller for controlling the image processing unit to
convert a color model of the selected image to a Hue, Saturation, and Intensity (HSI) color model, extract color values,
map the extracted color values,
assign priority to the colors by measuring distribution ratios of the mapped color values,
combine the display colors of the menu screen based on the priority of the assigned colors, and
finally determine the display colors of the menu screen by analyzing contrast of the combined colors.

### BRIEF DESCRIPTION OF THE DRAWINGS

The above and other features and advantages of the present invention will become more apparent from the following detailed description when taken in conjunction with the accompanying drawing in which:

FIGS. 1A and 1B are diagrams illustrating a method of changing colors of a menu screen in a conventional wireless terminal;

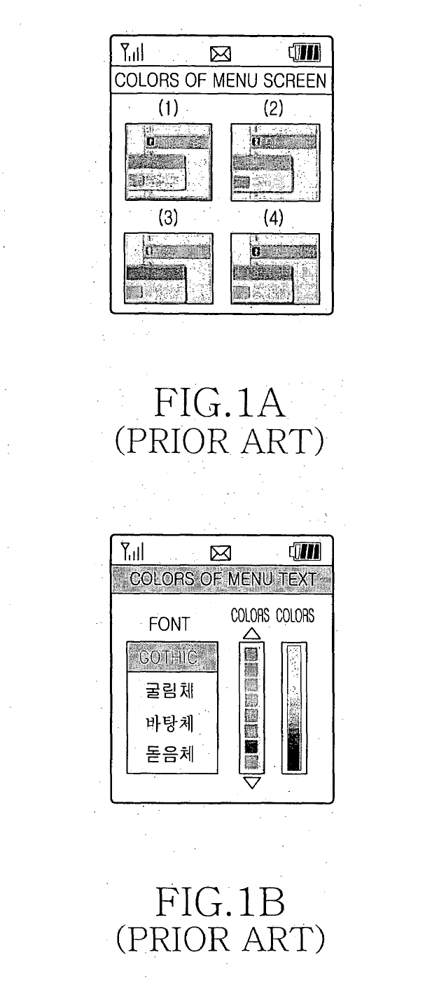

FIG. 2 is a block diagram illustrating a wireless terminal according to an embodiment of the present invention;

FIG. 3 is a flowchart illustrating a method of personalizing display colors of a menu screen using color information of an image according to an embodiment of the present invention;

FIGS. 4A and 4B illustrate screens whose display colors are changed using color information of different images according to an embodiment of the present invention; and

FIG. 4C illustrates a wireless terminal to which the menu screen changed to the black and white colors, which is illustrated in FIG. 4B, has been applied.

### DETAILED DESCRIPTION

Exemplary embodiments of the present invention are described herein below with reference to the accompanying drawings. For the purposes of clarity and simplicity, well-known functions or constructions are not described in detail since they may obscure the invention with unnecessary detail.

In the embodiments of the present invention, a wireless terminal indicates a cellular phone, a personal information terminal, a Personal Communication Services (PCS) phone, an International Mobile Telecommunication (IMT)-2000 terminal, a Global System for Mobile Communication (GSM) terminal, a Personal Digital Assistant (PDA), a smart phone, a Portable Multimedia Player (PMP), and the like, which includes a Digital Multimedia Broadcasting (DMB) receiving module for receiving digital broadcasting and a camera module.

In addition, a plurality of images stored in the wireless terminal in order to personalize display colors of a menu screen include images downloaded from a service provider, images captured by a camera with which the wireless terminal is equipped, and multimedia data images received through a DMB service.

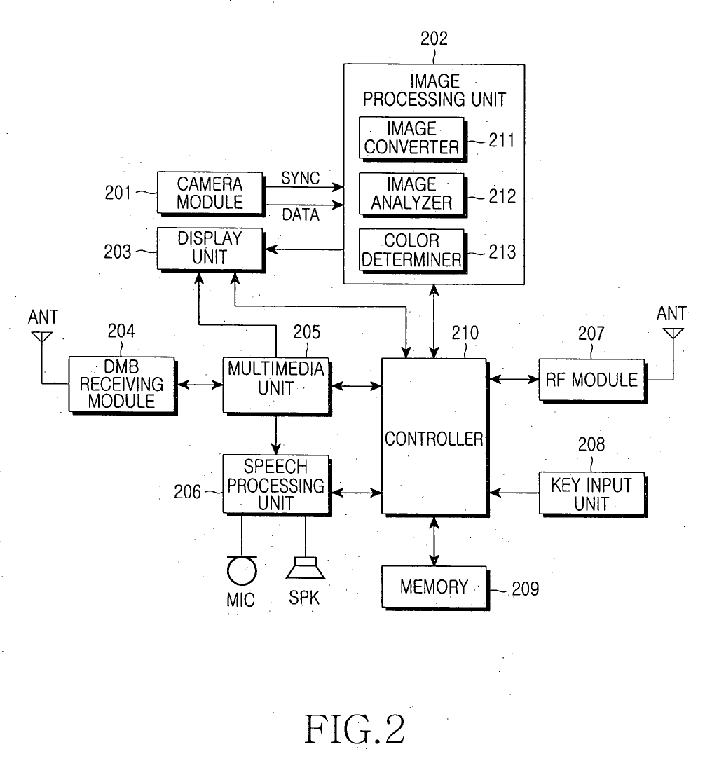

FIG. 2 is a block diagram of a wireless terminal according to an embodiment of the present invention.

Referring now to FIG. 2, the wireless terminal includes: a camera module 201 connected to an image processing unit 202, a display unit 203 connected to a DMB receiving module 204 which is connected to a multimedia unit 205 which is connected to a speech processing unit 206 wherein the multimedia unit 205 and the speech processing unit 206 are connected to a controller 210; a Radio Frequency (RF) module 207, a key input unit 208, and a memory 209 which are all connected to the controller 210.

The camera module 201 preferably includes a lens module (not shown) that can be exposed or hidden and captures an image.

The camera module 201 also preferably includes a camera sensor (not shown) for converting an optical signal, obtained by capturing an image, to an electrical signal and a signal processing unit (not shown) for converting to digital data the analog image signal received from the camera sensor. Herein, it is assumed for discussion purposes only, that the camera sensor is a charge coupled device (CCD), and the signal processing unit is implemented by a digital signal processor (DSP). The camera sensor and the signal processing unit are preferably implemented as one of one component and individual components.

In an embodiment, the camera module 201 captures images, used to personalize display colors of a menu screen, under control of the controller 210.

The image processing unit 202 generates screen data to display the digital data output from the camera module 201, wherein the screen data is used for at least one of an image to be output as a background image and an image with which to personalize the display colors of the menu screen.

In general, the image processing unit 202 processes the image signal output from the camera module 201 on a frame basis and outputs the frame image data by adjusting it to the characteristics and size of the display unit 203. The image processing unit 202 includes an image codec (not shown) and thereby compresses frame image data to be displayed on the display unit 203 according to a pre-set format or decompresses compressed frame image data to original frame image data. In addition, in an embodiment, the image processing unit 202 has an On Screen Display (OSD) function, and therefore the controller 210 can control the image processing unit 202 to output OSD data based on the screen size to be displayed.

In an embodiment, the image processing unit 202 includes an image converter 211, an image analyzer 212, and an image determiner 213 which are now described in more detail.

The image converter 211 converts a Red, Green, and Blue (RGB) color model or a YUV color model of an image selected to personalize the display colors of the menu screen to a Hue, Saturation, and Intensity (HSI) color model. The purpose of converting the RGB or YUV color model to the HSI color model is to extract color values of the entire image and map the extracted color values.

In general, the RGB color model requires 8 bits per primary color to express a natural color. That is, if R=8 bits, G=8 bits, and B=8 bits, a total of 2²⁴, i.e., 16,777,216, colors can be expressed.

In an 8-bit image system, 256 colors can be expressed by assigning 3 bits to R, 3 bits to G, and 2 bits to B. That is, in a system having a limited number of bits, a least number of bits are generally assigned to the blue color to which human eyes are most insensitive.

Table 1 illustrates the number of bits assigned to each primary color in order to express each color when each primary color is expressed with 8 bits.

TABLE 1

| Color | Red | Green | Blue |
|---|---|---|---|
| Red | 255 | 0 | 0 |
| Green | 0 | 255 | 0 |
| Cyan | 0 | 0 | 255 |
| Magenta | 255 | 255 | 0 |
| Yellow | 0 | 255 | 255 |
| Black | 0 | 0 | 0 |
| White | 255 | 255 | 255 |
| Dark | 76 | 76 | 76 |
| Gray | 123 | 123 | 123 |
| Light Gray | 123 | 123 | 123 |

If each primary color is expressed with 8 bits, each primary color can have a color value in a range of 0 to 255. Since each of the 3 primary colors can have a color value in a range of 0 to 255, all colors can be expressed by properly adjusting color values of the 3 primary colors. As illustrated in Table 1, the white color can be expressed when a color value of the red color is 255, a color value of the green color is 255, and a color value of the blue color is 255. The black color can be expressed when the color values of the 3 primary colors are all 0. The RGB color model is mainly used for Cathode Ray Tube (CRT) monitors, computer graphic systems, and the like.

The YUV color model is based on the fact that human eyes are more sensitive to brightness than color tone, wherein each color is expressed with 3 kinds of information, i.e., Y denoting a luminance signal, U denoting a difference between the luminance signal and a red component, and V denoting a difference between the luminance signal and a blue component. The typical ratio of Y:U:V is 4:2:2, and the YUV color model is mainly used for TVs.

The HSI color model has 3 features of hue denoting pure color, saturation denoting how much white color is added, and intensity denoting color brightness. In the HSI color model, a user does not have to know how much percentage of blue or green color is required to express a color.

That is, a deep red color can be changed to a pink color by adjusting saturation of the dark red color in the HSI color model. A dark color can be changed to a bright color by adjusting intensity. Thus, the HSI color model is used for various applications. For example, image processing applications, such as histogram calculation, intensity conversion, and revolution, perform calculations of only intensity of an image. In the present invention, it is preferable for the image processing applications to calculate an image in an HSI color space rather than other color spaces.

If an image, selected by the user to personalize the display colors of the menu screen, is in the RGB color model, the image converter 211 converts the RGB color model of the image to the HSI color model using Equation 1.

$$I = \frac{1}{3} ( R + G + B ) \\ S = 1 - \frac{3}{( R + G + B )} [ min ( R , G , B ) ] \\ H = {cos}^{- 1} [ \frac{\frac{1}{2} [ ( R - G ) + ( R - B ) ]}{\sqrt{{( R - G )}^{2} + ( R - B ) ( G - B )}} ] \qquad ( 1 )$$

The image converter 211 can obtain hue, saturation, and intensity values of the image converted to the HSI color model using Equation 1. Although the conversion from the RGB color model to the HSI color model is explicitly described, it will be understood by those skilled in the art that a method of converting the YUV color model or a YCbCr color model to the HSI color model is also applicable and therefore implicitly disclosed and that the RGB color model is used herein for discussion purposes only and not in any limiting sense.

When the image to be used to personalize the display colors of the menu screen is converted from the RGB color model to the HSI color model, the image analyzer 212 obtains hue information from all over the image converted to the HSI color model and maps color values based on the hue information. If the color values are mapped to the entire image, the image analyzer 212 measures distribution ratios of the mapped color values.

After the measurement of the distribution ratios of the mapped color values is completed, the image analyzer 212 assigns priority in an order from a color showing a dominant distribution of the image to a color showing a least dominant distribution. In an embodiment, a color priority is assigned by dividing colors forming the entire image according to types, measuring a ratio of each of the types of divided colors, and comparing the measured ratios to each other.

However, the color priority can be assigned using a pre-set method determined when the wireless terminal was manufactured by a manufacturer of the wireless terminal or assigned by a user's selection, and thus, a method of assigning the color priority is not limited to the exemplary method disclosed herein in an embodiment.

After the priority of each of the colors forming the image is assigned, the image analyzer 212 combines colors in an order from a color having the highest priority to a color having a lowest priority, which colors are used to personalize the display colors of the menu screen.

When the colors to be used to personalize the display colors of the menu screen are combined according to their priorities, the color determiner 213 finally determines a combination of colors with which to display the menu screen by analyzing contrast of the combined colors. The contrast analysis of the combined colors is achieved by measuring a contrast ratio of each of the colors having the highest priority, which were combined by the image analyzer 212.

The menu screen can be basically comprised of text, a text background, and an overall background. If a contrast ratio of a color of the text to a color of the text background is greater than 90% based on 100%, it may be difficult for the user to use the wireless terminal because the user cannot distinguish the text from the text background.

For example, if the text color is red and the text background color is pink, a contrast ratio of the two colors will be greater than 90%. In this case, although the priority of colors combined to display the menu screen is the highest, when the combination of the colors results in difficulty in reading text to the user due to the color contrast, a final color combination is determined using a color having a second highest priority.

However, if a dominant color occupies most (greater than 90%) of the entire image as in a monochrome image, the user can determine a final color combination by acquiring desired colors through adjustment of a saturation and an intensity value of a text, a text background, and an overall background.

When the color determiner 213 finally determines a combination of colors to be used to personalize the display colors of the menu screen through the above-described process, the controller 210 changes colors of the text, the text background, and the overall background to the finally determined colors and displays on the display unit 203 the text, the text background, and the overall background having the changed colors.

The display unit 203 can include a Liquid Crystal Display (LCD) and outputs various kinds of display data created by the wireless terminal. In an embodiment, if the LCD is implemented using a touch screen scheme, the display unit 203 can operate as an input module.

The display unit 203 displays an image signal output from the image processing unit 202 on a screen and displays user data output from the controller 210. In an embodiment, the controller 210 controls the display unit 203 to display the text, the text background, and the overall background of the menu screen using the combination of the colors finally determined by the color determiner 213.

The controller 210 controls the DMB receiving module 204 to receive and demodulate predetermined DMB data and outputs the demodulated DMB data to the multimedia unit 205. The DMB receiving module 204 further includes a demodulator (not shown) for demodulating the received DMB data to a digital data stream.

The multimedia unit 205 demultiplexes the DMB data input from the DMB receiving module 204 into an image signal and an audio signal, decodes the demultiplexed image signal and audio signal to an analog image signal and an analog audio signal, and outputs the decoded analog image signal and the decoded analog audio signal to the display unit 203 and the speech processing unit 206, respectively.

The controller 210 controls the multimedia unit 205 to store the DMB data input from the DMB receiving module 204 in the memory 209. A moving picture of the DMB data stored in the memory 209 can also be used as an image to personalize the display colors of the menu screen by extracting an Intra coded (I) picture, which is a component of the moving picture. Since a method of extracting the I picture is known in the art, a description of the I picture extracting method is omitted.

The speech processing unit 206 modulates an electrical signal input through a microphone to speech data, and demodulates encoded speech data input from the RF module 207 to an electrical signal and outputs the electrical signal to a speaker.

In an embodiment, the speech processing unit 206 includes a codec to convert a digital audio signal input through the RF module 207 to an analog audio signal and to convert an analog audio signal input through the microphone to a digital audio signal. The codec comprises a data codec for processing packet data and an audio codec for processing an audio signal such as speech.

The controller 210 controls the RF module 207 to transmit and receive speech data, text data, image data, and control data. To do this, the RF module 207 includes an RF transmitter (not shown) for upstream converting a frequency of a signal to be transmitted and amplifying the signal to be transmitted, and an RF receiver (not shown) for low noise amplifying a received signal and downstream converting a frequency of the received signal. In an alternative embodiment, the RF module 207 includes a modem (not shown) including a transmitter for encoding and modulating the signal to be transmitted and a receiver for demodulating and decoding the received signal.

The key input unit 208 receives a user operating signal, such as a key input or a speech input, and outputs the user operating signal to the controller 210.

The memory 209 stores various kinds of information required for controlling operation of the wireless terminal. The controller 210 controls the memory 209 to store an image captured by the camera module 201 and store a DMB data received through the DMB receiving module 204.

The controller 210 controls general operation of the wireless terminal. In an embodiment, if the user inputs a signal to personalize the display colors of the menu screen using color information of an image, the controller 210 determines whether an image is stored in the memory 209. If it is determined that no image is stored in the memory 209, the controller 210 controls the display unit 203 to display a message for informing the user that no image is stored in the memory 209. When the user confirms through a message that no image is stored in the memory 209, the user captures an image by controlling the camera module 201 included in the wireless terminal and stores the captured image in the memory 209.

When the user selects an image to be used to personalize the display colors of the menu screen from among images stored in the memory 209, the controller 210 controls the image processing unit 202 to convert an RGB or YUV color model of the selected image to an HSI color model. When a color model of the selected image is converted to the HSI color model, the controller 210 controls the image processing unit 202 to obtain hue information included in the image converted to the HSI color model and map color values.

When the color values of the entire image are mapped by the image processing unit 202, the controller 210 controls the image processing unit 202 to measure distribution ratios of the mapped color values and assign priorities thereto in an order from a most dominant color having a highest priority to a least dominant color having a lowest priority.

When the priority of each of colors forming the image has been assigned, the controller 210 controls the image processing unit 202 to combine colors in an order from a color having the highest priority to a color having the lowest priority, which are used to personalize the display colors of the menu screen. The controller 210 controls the image processing unit 202 to analyze contrast of the combined colors and finally determine a combination of colors to display the menu screen according to the contrast analysis result.

After the combination of colors to display the menu screen is finally determined, if an output signal is input by the user, the controller 210 controls the display unit 203 to display the menu screen having the display colors, which have been changed to the finally determined combination of colors.

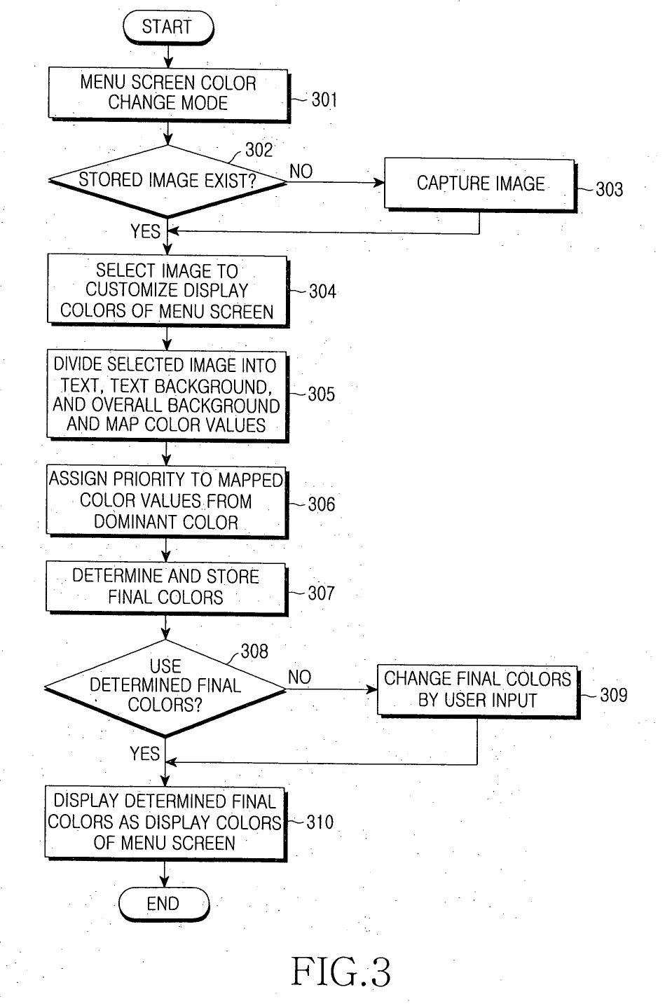

FIG. 3 illustrates a flowchart illustrating a method of personalizing display colors of a menu screen using color information of an image, according to an embodiment of the present invention.

Referring to FIG. 3, if a menu screen color change mode entry signal for changing the display colors of the menu screen is input by a user in step 301, the controller 210 determines in step 302 whether an image is stored in the memory 209.

If it is determined in step 302 that no image is stored in the memory 209, the controller 2 10 controls the display unit 203 to display a message for informing the user that no image is stored in the memory 209. When the user confirms through the display unit 203 that no image is stored in the memory 209, the user captures an image by controlling the camera module 201 included in the wireless terminal and stores the captured image in the memory 209 in step 303. Here, the image to be used to personalize the display colors of the menu screen may also be one of an image downloaded from a service provider and a screen image of a DMB program received through the DMB receiving module 204.

When the user selects an image to be used to personalize the display colors of the menu screen from among images stored in the memory 209 in step 304, the controller 210 controls the image processing unit 202 to convert an RGB or YUV color model of the selected image to an HSI color model, obtain hue information included in the image converted to the HSI color model, and map color values in step 305.

When the color values of the entire image are mapped by the image processing unit 202, the controller 210 controls the image processing unit 202 to measure distribution ratios of the mapped color values and assign priorities in an order from a most dominant color to a least dominant color in step 306.

When the priority of each of colors forming the image is assigned, the controller 210 controls the image processing unit 202 to combine colors in an order from a color having a highest priority to a color having a lowest priority, which are used to personalize the display colors of the menu screen. The menu screen comprises text, a text background, and an overall background.

In an embodiment, a color priority is assigned by dividing colors forming the entire image according to types, measuring a ratio of each type of the divided colors, and comparing the measured ratios to each other.

When the priority is assigned in an order from a most dominant color to a least dominant color, the controller 210 controls the image processing unit 202 to analyze contrast of the combined colors and finally determine a combination of colors to display the menu screen according to the contrast analysis result in step 307. The contrast analysis of the combined colors is achieved by measuring a contrast ratio of each of the colors having the higher priority, which were combined by the image analyzer 212.

When the priority of each of colors forming the image is assigned, the controller 210 controls the image processing unit 202 to combine colors in an order from a color having the highest priority to a color having the lowest priority, which are used to personalize the display colors of the menu screen. If a contrast ratio of a color combination of the text, the text background, and the overall background is measured as greater than 90%, it may be difficult for the user to use the wireless terminal to read text due to the color contrast.

Although the priority of colors combined to display the menu screen is the highest, if this combination of the colors results in difficulty in reading text to the user due to the color contrast, a combination of colors to personalize the display colors of the menu screen is finally determined using a color having a second highest priority.

Once the contrast of the combined colors is analyzed and the combination of colors to display the menu screen is finally determined by the image processing unit 202, the controller 210 controls the display unit 203 to display a message indicating that the colors to display the menu screen have been finally determined. The user confirms the message displayed on the display unit 203 and determines in step 308 whether colors of the menu screen are to be changed to the finally determined colors.

If the user wants to change the finally determined colors to other colors, or if a dominant color occupies most (greater than 90%) of the entire image as in a monochrome image, the user newly determines desired final colors by adjusting saturation and intensity values of the text, the text background, and the overall background in step 309. When the final colors are determined, the controller 210 controls the display unit 203 to display the determined final colors as the display colors of the menu screen in step 310.

Through the above-described method, the display colors of the menu screen can be personalized using color information of an image.

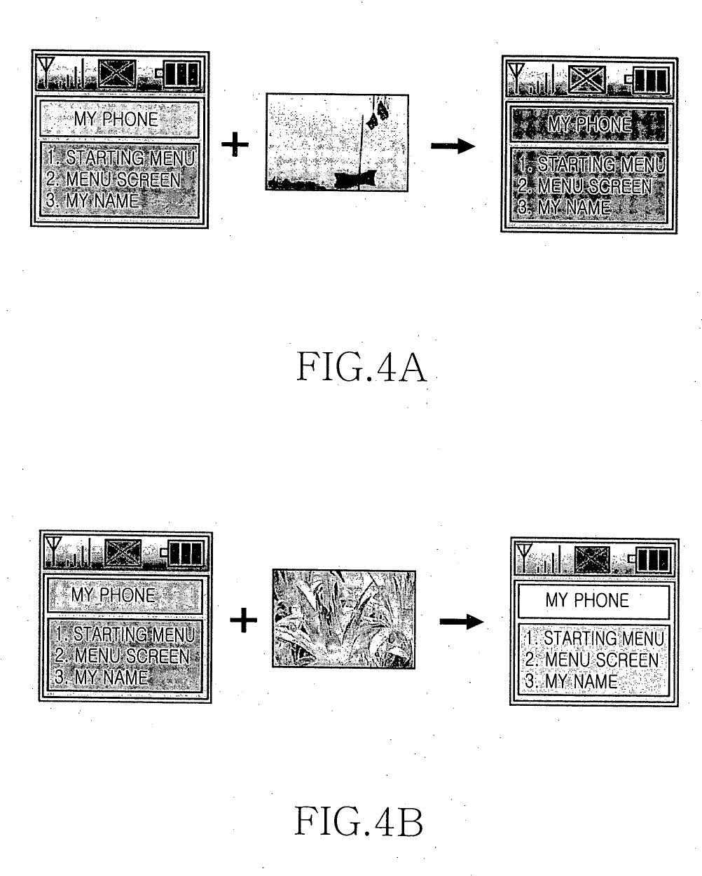

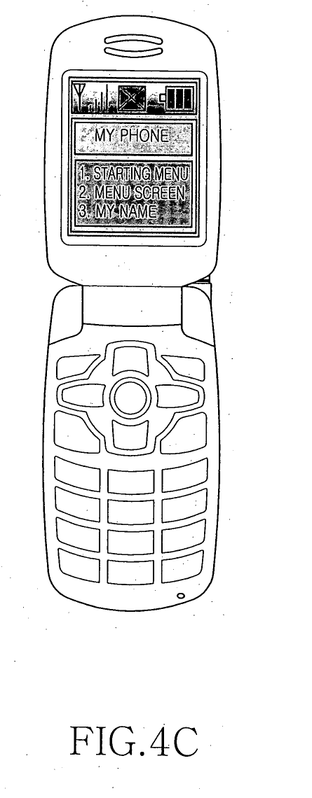

FIGS. 4A to 4C illustrate screens whose display colors are changed using color information of an image according to a preferred embodiment of the present invention.

FIGS. 4A and 4B illustrate conventional menu screens, images to personalize display colors of the menu screens, and the menu screens whose display colors are changed to color information of the images according to the present invention.

Referring to FIG. 4A, the colors of the conventional menu screen, which are combined based on the blue color, are changed to the colors of the menu screen, which are combined based on the red color according to colors of a flower image.

When the red color image is selected to personalize the display colors of the menu screen, the controller 210 controls the image processing unit 202 to convert an RGB or YUV color model of the selected image to an HSI color model. The purpose of converting the RGB or YUV color model to the HSI color model is to obtain color values of the entire image, map the obtained color values to the entire image, and assign priority of colors by measuring distribution ratios of the mapped color values.

The menu screen comprises text, a text background, and an overall background. A color configuration of the menu screen is changed according to the color priority assigned by the image processing unit 202. In addition, a color combination of the text, the text background, and the overall background forming the menu screen is determined according to a contrast analysis result of the selected image. The contrast analysis is achieved by measuring a contrast ratio of each of the colors having a highest priority, which were combined by the image processing unit 202. If a contrast ratio of colors having a highest priority is greater than 90% based on 100%, a color having the second highest priority is selected, and a color combination of the text, the text background, and the overall background is determined using the selected color.

When the priority of each of colors forming the image is assigned, the controller 210 controls the image processing unit 202 to combine colors in an order from a color having the highest priority to a color having the lowest priority, which are used to personalize the display colors of the menu screen. Although the priority of colors combined to display the menu screen is the highest, if this combination of the colors results in difficulty to the user in reading text due to the color contrast, a combination of colors to personalize the display colors of the menu screen is finally determined using a color having the second highest priority. In this case, in order to increase readability of the text regardless of an original image, the colors of the text and the text background must be selected with a pair of colors having a higher color gradation.

FIG. 4B illustrates a case where an image used to personalize the display colors of the menu screen is a monochrome image, wherein a dominant color occupies most (greater than 90%) of the entire image. As illustrated in FIG. 4B, the colors of the conventional menu screen, which are combined based on the blue color, are changed to black and white colors according to the colors of the monochrome image.

If a dominant color of the monochrome image illustrated in FIG. 4B occupies most (greater than 90%) of the entire image, a contrast ratio of the colors according to a contrast analysis result is greater than 90%. In this case, this combination of the colors results in difficulty in reading text to the user due to the color contrast.

The user can determine final colors to be used to personalize the display colors of the menu screen by acquiring desired colors through adjustment of saturation and intensity values of the text, the text background, and the overall background.

FIG. 4C illustrates a wireless terminal to which the menu screen changed to the black and white colors, which is illustrated in FIG. 4B, is applied. Using the above-described method, the user can independently set a menu environment in which colors of the wireless terminal match colors of the menu screen displayed on the display unit 203.

As described above, according to the present invention, by personalizing colors of a menu screen using an image stored in a wireless terminal, an environment for implementing specific menu colors can be provided, a complicated color selection process can be simplified, and a personality of a user can be expressed.

While the invention has been illustrated and described with reference to certain preferred embodiments thereof, it will be understood by those skilled in the art that various changes in form and details may be made therein without departing from the spirit and scope of the invention as defined by the appended claims.

What is claimed is:

1. A wireless terminal for personalizing display colors of a menu screen thereof using color information of an image, the wireless terminal comprising:
a camera module for capturing an image;
a memory for storing at least the image captured by the camera module;
an image processing unit for determining colors used to display the menu screen by using color information of an image for personalizing the display colors of the menu screen, said image being selected from at least one image stored in the memory;
a controller for controlling the image processing unit to personalize the display colors of the menus screen according to a contrast analysis of the color information of the selected image; and
a display unit for displaying the menu screen with the colors determined by the image processing unit.

2. The wireless terminal of claim 1, wherein the controller is further configured to control the image processing unit to perform the contrast analysis to
convert a color model of the selected image to a Hue, Saturation, and Intensity (HSI) color model,
extract color values, and map the extracted color values,
assign priority to the colors by measuring distribution ratios of the mapped color values,
combine the display colors of the menu screen based on the priority of the assigned colors, and
determine the final display colors of the menu screen by analyzing contrast of the combined colors.

3. The wireless terminal of claim 1, wherein the image processing unit comprises:
an image converter for converting a color model of the selected image to a Hue, Saturation, and Intensity (HSI) color model;
an image analyzer for extracting color values included in the image converted to the HSI color model by the image converter, mapping the extracted color values, assigning priority to the mapped color values by measuring distribution ratios of the mapped color values, and combining the display colors of the menu screen according to the assigned color priority; and
a color determiner for determining final colors with which to display the menu screen by analyzing contrast of the colors combined by the image analyzer.

4. The wireless terminal of claim 1, wherein the contrast analysis process of the combined colors is a process of contrasting the colors having higher priority, which are combined by the image analyzer, and measuring a contrast ratio of the contrasted colors.

5. The wireless terminal of claim 4, wherein if the contrast ratio of the combined colors is greater than 90% as a contrast analysis result of the combined colors, a final combination of colors is determined using a color having the second highest priority.

6. The wireless terminal of claim 4, wherein if a dominant color of a monochrome image occupies greater than 90% of the image as a contrast analysis result of the combined colors, a final combination of colors is determined by acquiring desired colors through adjustment of saturation and intensity values of the menu screen.

7. The wireless terminal of claim 1, wherein the menu screen comprises a text, a text background, and an overall background.

8. A method of personalizing display colors of a menu screen of a wireless terminal using color information of an image, the method comprising the steps of:
selecting an image to be used to personalize the display colors of the menu screen from images stored in a memory of the wireless terminal;
converting a color model of the selected image to a Hue, Saturation, and Intensity (HSI) color model, extracting color values from the converted color model, and mapping the extracted color values according to a predetermined technique;
combining the display colors of the menu screen by measuring distribution ratios of dominant colors using the mapped color values and assigning priorities to the measured colors; and
personalizing the display colors of the menu screen by analyzing a contrast of the combined colors.

9. The method of claim 8, wherein the step of selecting further comprises the step of when no image is stored in the wireless terminal performing the steps of:
displaying a message indicating that a currently stored image does not exist in the memory of the wireless terminal;
the user providing an image; and
storing the provided image in the memory.

10. The method of claim 8, wherein the combining step further comprises the steps of:
assigning a priority to each of the measured colors by dividing the measured colors that form the image according to types;
measuring a ratio of each of the types of the divided colors; and
comparing the measured ratios to each other.

11. The method of claim 8, wherein the step of personalizing further comprises the step of when a contrast ratio of the combined colors is greater than 90% as a contrast analysis result of the combined colors, in order to increase readability of text regardless of combined colors, selecting colors of a text, a text background, and an overall background having a higher color gradation.

12. The wireless terminal of claim 1, wherein the images to personalize the display colors of the menu screen comprise images downloaded from a service provider, images captured by the camera module, and multimedia data images received using a DMB service.
